(19) United States
(12) Patent Application Publication
(10) Pub. No.: US 2012/0295782 A1
(43) Pub. Date: Nov. 22, 2012

(54) HERMETIC CENTRIFUGAL SEPARATOR

(75) Inventors: Jouko Pitkämäki, Eskilstuna (SE); Robert Sandblom, Alvsjo (SE)

(73) Assignee: ALFA LAVAL CORPORATE AB, Lund (SE)

(21) Appl. No.: 13/505,902

(22) PCT Filed: Nov. 3, 2010
(86) PCT No.: PCT/SE10/51194

§ 371 Date: Jul. 13, 2012

(30) Foreign Application Priority Data
Nov. 6, 2009 (SE) 0950840-9

(51) Int. Cl. B04B 11/00

(52) U.S. Cl. 494/41

(57) ABSTRACT

A hermetic centrifugal separator for centrifuging components, contained in a liquid mixture and having different density, comprises a rotating centrifuge rotor, which is arranged to rotate around a centre axis and comprises a casing which defines an inner separation space, a set of separation discs which are provided in the inner separation space of the centrifuge rotor, at least two channels, which connect to the separation space and comprise at least one inlet channel for supply of the liquid mixture of components to be separated to the separation space and at least one outlet channel for discharge of a component separated during operation from the separation space, a torque transmitting part around the centre axis and fixedly connected to the centrifuge rotor adapted to be driven in such a way that the centrifuge rotor is brought to rotate, outlet sealing means arranged to seal between the outlet channel and the rotating centrifuge rotor preventing entrainment of unwanted substances. To come to terms with the pressure drop in the separator, and especially in the area of the outlet sealing the invention is characterized in that between the separation space and said outlet sealing means is a pumping means arranged to provide pressure to feed the separated liquid through said outlet channel.

### FIELD OF THE INVENTION

The present invention relates to a hermetic centrifugal separator for centrifuging components contained in a liquid mixture and having different density.

More particularly, the invention relates to such hermetic centrifugal separators comprising a rotating centrifuge rotor, which is arranged to rotate around a central axis and comprises a casing which defines an inner separation space, a set of separation discs which are provided in the inner separation space of the centrifuge rotor. The hermetic centrifuge has at least two channels, which connect to the separation space and comprise at least one inlet channel for supply of the liquid mixture of components to be separated to the separation space and at least one outlet channel for discharge of a component separated during operation from the separation space. The hermetic centrifuge has a torque transmitting part around the central axis and fixedly connected to the centrifuge rotor adapted to be driven in such a way that the centrifuge rotor is brought to rotate. The hermetic centrifuge has outlet sealing means arranged to seal between the outlet channel and the rotating centrifuge rotor preventing entrainment of unwanted substances,

### BACKGROUND

In certain separator applications, the separation fluid during the separation process is kept under special hygienic conditions and/or without any air entrainment and high shear forces, such as when the separated product is sensitive to such influence. Examples of that kind are separation of dairy products, beer and in biotechnology applications. For such applications, so called hermetic separators have been developed and in production for a number of years.

In a hermetic separator, the separator bowl or centrifuge rotor is completely filled with liquid during operation. This means that no air or free liquid surfaces is meant to be present in the bowl. As can be seen in FIG. 1 which discloses a previously known hermetic centrifugal separator, the fluid to be separated enters the centrifuge rotor 1 from the bottom through a hollow spindle pipe 2 forming a hermetic inlet 3. This provides a gentle acceleration of the fluid having shear-sensitive contents. The feed is then accelerated in a distributor 4 before entering a disc stack 3 comprising separator discs where the separation takes place. The liquid phase moves towards the center of the centrifuge rotor 1, where the liquid phase is pumped out under pressure by means of a built-in pump disc 6 to at least obtain a required outlet pressure. The separated heavier solids phase is collected at the periphery of the centrifuge rotor 1, from where the solids are discharged intermittently through solids ports 7.

However, the pressure drop inside the separator is not reduced. The main part of this pressure drop arises in the narrow section where the fluid passes the outlet sealing.

In order to create a flow of process fluid through a hermetic separator, an inlet pressure has to be provided to overcome the pressure drop in the separator. The inlet pressure required at a certain capacity is often higher than desired. This provides a problem, especially within areas with a requirement of soft treatment of the process fluid such as biotechnology. Thus, a contradiction between high capacity and quality of separation product appears.

In beer separation, the required inlet pressure can be high, caused by carbon dioxide leaving the fluid which in its turn may cause cavitation. It also leads to capacity problems, as the process fluid flow will be reduced.

A part of the pressure drop over the separator arises in the narrow section where the fluid passes the outlet sealing.

### SUMMARY OF THE PRESENT INVENTION

It is an aim of the present invention to provide a hermetic separator which reduces the above-mentioned problems of the present technology.

This and other aims are achieved, according to the present invention, by that between said separation space and said outlet sealing means, a pumping means is arranged to provide pressure to feed the separated liquid through said outlet channel

In an embodiment of the present invention, the pumping means is a non-rotating stationary arrangement adapted to direct the separated liquid inwardly towards the center axis in order to increase the pressure in the outlet channel.

In another embodiment of the present invention, the pumping means comprises radially extended arc-formed teeth directed in a counter-rotational direction.

In yet another embodiment of the present invention, the pumping means also comprises a stem-like member which by a first end is attached to a stationary part of the separator and from a second end of which the arc-formed teeth extend.

In a further embodiment of the present invention, said pumping means further comprises a disc which disc with its center of its surface facing away from the separation space is attached perpendicularly to the second end, and where the disc is at least in contact with the arc-formed teeth.

In another embodiment of the present invention, the arc-formed teeth are evenly spaced along the circumference of the disc and are identically curved.

In another embodiment of the present invention, the arc-formed teeth extend outside the periphery of the disc.

In yet another embodiment of the present invention, the arc-formed teeth are attached to the surface of the disc.

### BRIEF DESCRIPTION OF THE DRAWINGS

The invention is now being explained more in detail by means of a description of advantageous embodiments, which are examples of possible realizations of the present invention, and with reference to the drawings attached hereto.

FIG. 1 is a schematic side view of a hermetic centrifugal separator according to prior art.

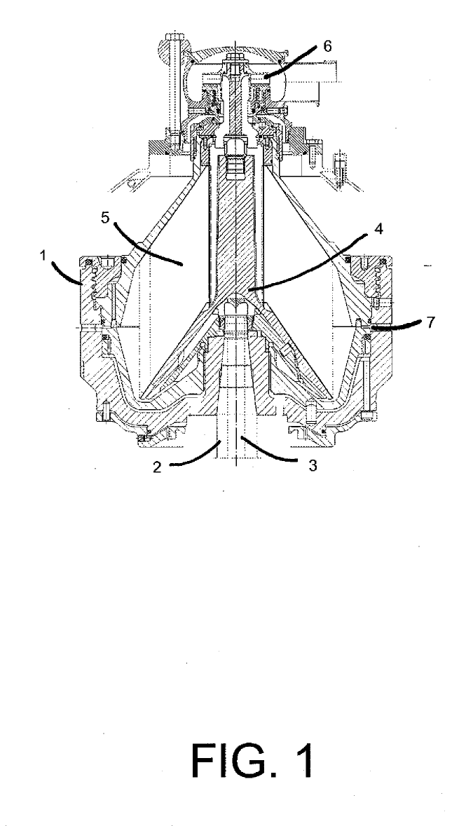

FIG. 2 is a schematic side view of a hermetic centrifugal separator according to the present invention.

FIG. 3 is a perspective view of a part of the pumping means according to an embodiment of the present invention.

### DETAILED DESCRIPTION

A centrifugal separator comprises a stationary frame. The frame comprises a base intended to be located on a suitable substrate, such as a floor, and a stationary casing which is provided on the frame. The centrifugal separator comprises a rotating torque transmitting part, which is journalled in the frame and which extends along a center axis. The torque transmitting part is driven by a drive motor which may be an electric, hydraulic or pneumatic drive motor.

The centrifugal separator also comprises a centrifuge rotor, which is fixedly attached on the torque transmitting part. The centrifuge rotor is provided in the stationary casing and is provided with a rotor casing defining an inner separation space.

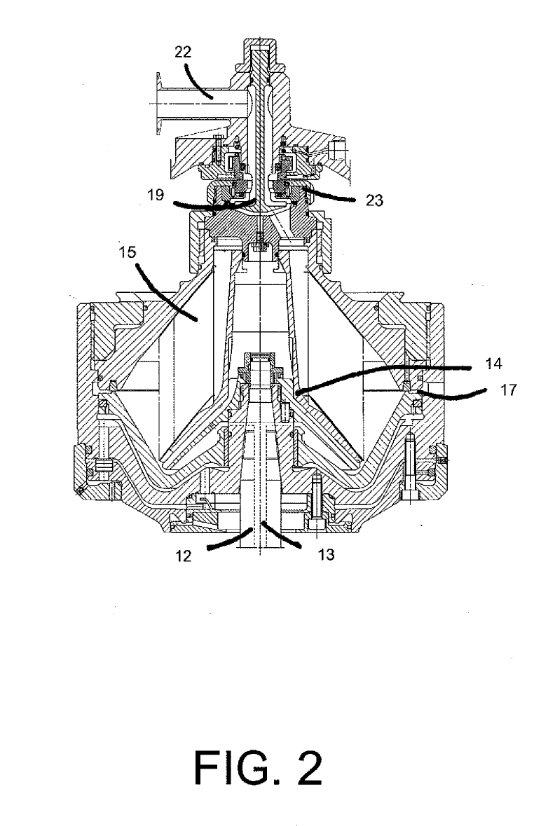

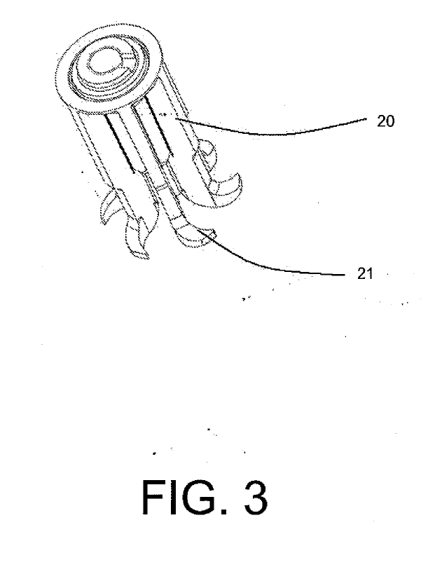

FIG. 2 discloses a vertical sectional view of a preferred embodiment of a hermetical separator according to the present invention. In the embodiment in FIG. 2, the centrifugal separator comprises a centrifuge rotor 11, which is fixedly attached on a torque transmitting part 12 designed as a hollow spindle in which an inlet channel 13 is arranged. The inlet channel 13 is provided to supply separation fluid into the separation space 18, which fluid is to be cleaned by centrifugal separation. The centrifugal separator also comprises a disc stack comprising a set of separation discs which are provided in the inner separation space 18 of the centrifuge rotor 11 and rotate with the centrifuge rotor 11. In one embodiment, the discharge of the cleaned product takes place through an outlet channel 22 at the upper end of the centrifuge rotor 11. In a narrow passage of the outlet channel 22 is an outlet sealing 23 arranged sealing off between the outlet channel and the centrifugal rotor from possible penetration of air and contamination from the environment. Upstreams of the outlet sealing 23 in the outlet channel 22 is a pumping means 19 arranged in the center of a chamber in communication with the separation space. In the embodiment disclosed in FIG. 2 and FIG. 3, the pumping means 19 comprises a disc and a stem-like member attached to the center of the disc and extending from a surface of the disc facing away from the separation space, which stem-like member in its other end is attached to the stationary casing and having a symmetry axis coinciding with an extension of the rotational axis of the centrifugal rotor. From the end of the stem-like member extend radially outwardly arc-formed teeth 21. The surface of the disc is in contact with the teeth 21 which thus form arc-formed ridges protruding from the surface. The teeth 21 are evenly spaced along the circumference of the disc and may be identically curved and may as in FIG. 2 extend outside the periphery of the disc. The arc-formed teeth 21 are directed in a counter-rotational direction. In one embodiment, the arc-formed teeth 21 are attached to the surface of the disc.

The function of the pumping means 19 is as follows. The rotating separated fluid is led from the separation space to the chamber and as it still has rotational energy it is rotating in the chamber. The arc-formed teeth 21 are leading a certain amount of the rotating fluid along the arc-shapes inwardly towards the stem-like member and the center axis. Some of the kinetic energy in the rotating fluid is thus converted to pressure energy by the pumping means 19. The fluid is further led along the stem-like member past the narrow passage where the outlet sealing 23 is situated and further to an outlet orifice in the outlet channel 22. The pumping means 19 is thus compensating for the pressure drop caused by the narrow passage of the outlet sealing 23.

The invention is not limited to the embodiments disclosed but may be varied and modified within the scope of the following claims.

What is claimed is:

1-8. (canceled)

9. A hermetic centrifugal separator for centrifuging components, contained in a liquid mixture and having different density, comprising:
a rotating centrifuge rotor, which is arranged to rotate around a central axis and comprises a casing which defines an inner separation space;
a set of separation discs which are provided in the inner separation space of the centrifuge rotor;
at least two channels, which connect to the separation space and comprise at least one inlet channel for supply of the liquid mixture of components to be separated to the separation space and at least one outlet channel for discharge of a component separated during operation from the separation space;
a torque transmitting part around the central axis and fixedly connected to the centrifuge rotor adapted to be driven in such a way that the centrifuge rotor is brought to rotate;
outlet sealing means arranged to seal between the outlet channel and the rotating centrifuge rotor preventing entrainment of unwanted substances; and
between said separation space and said outlet sealing means is a pumping means arranged to provide pressure to feed the separated liquid through said outlet channel.

10. The centrifugal separator according to claim 9, wherein the pumping means is a non-rotating stationary arrangement adapted to direct the separated liquid inwardly towards the center axis in order to increase the pressure in the outlet channel.

11. The centrifugal separator according to claim 10, wherein the pumping means comprises radially extended arc-formed teeth directed in a counter-rotational direction.

12. The centrifugal separator according to claim 11, wherein the pumping means also comprises a stem-like member which by a first end is attached to a stationary part of the separator and from a second end of which said arc-formed teeth extend.

13. The centrifugal separator according to claim 12, wherein said pumping means further comprises a disc which disc with its center of its surface facing away from the separation space is attached perpendicularly to said second end, and where said disc is at least in contact with said arc-formed teeth.

14. The centrifugal separator according to claim 13, wherein said arc-formed teeth are evenly spaced along the circumference of the disc and are identically curved.

15. The centrifugal separator according to claim 13, wherein said arc-formed teeth extend outside the perifery of the disc.

16. The centrifugal separator according to claim 13, wherein said arc-formed teeth are attached to said surface of the disc.
